(19) United States
(12) Patent Application Publication
(10) Pub. No.: US 2018/0322731 A1
(43) Pub. Date: Nov. 8, 2018

(54) Location Detection for Portable Wagering Game Machines

(71) Applicant: Bally Gaming, Inc., Las Vegas, NV (US)

(72) Inventor: Mark B. GAGNER, West Chicago, IL (US)

(21) Appl. No.: 16/028,007

(22) Filed: Jul. 5, 2018

Related U.S. Application Data
(63) Continuation of application No. 12/304,635, filed on Dec. 12, 2008, now abandoned.
(60) Provisional application No. 60/804,578, filed on Jun. 13, 2006.

(51) Int. Cl. G07F 17/32

(52) U.S. Cl. CPC G07F 17/3218; G07F 17/3223; G07F 17/32

(57) ABSTRACT

Systems and methods determine a location for a portable wagering game machine. The system may include a plurality of wireless signal sources, including wireless access points or Bluetooth type devices. The wireless signal sources may be arranged in predetermined locations such as a grid. In addition, a database may provide location information for the plurality of wireless signal sources.

### RELATED APPLICATION

This patent application claims the priority benefit of U.S. patent application Ser. No. 12/304,635, titled “LOCATION DETECTION FOR PORTABLE WAGERING GAME MACHINES”, filed Dec. 12, 2008, which is a 371 of PCT/US07/13891, filed Jun. 13, 2007, and which claims the priority benefit of U.S. Provisional Patent Application Ser. No. 60/804,578 filed Jun. 13, 2006 and entitled “LOCATION DETECTION FOR PORTABLE WAGERING GAME MACHINES”, the contents of each of which are incorporated herein by reference in their entirety.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, 2007, WMS Gaming Inc. All Rights Reserved.

### FIELD

The embodiments relate generally to portable wagering game machines and more particularly to detecting location or proximity of portable wagering game machines in gaming environments.

### BACKGROUND

Wagering game machines have traditionally been operated as a stand alone unit, or linked in a network of some type to a group of gaming machines. In general, these traditional wagering game machines are relatively large and have not been portable. That is, once placed on a casino floor the wagering game machine does not move unless it is replaced with another wagering game machine or if the gaming establishment redesigns the layout of the casino floor.

However, as technology in the gaming industry progresses, some jurisdictions are moving towards allowing portable gaming machines. Portable wagering game machines are typically small, handheld devices that may be taken from place to place. While such portability provides increased flexibility to gaming establishments and may enhance a user's wagering game experience, several issues are presented regarding portable wagering game machines. A first issue is that jurisdictions typically restrict wagering games to limited locations within a gaming establishment. Such restrictions are more difficult to enforce with portable wagering game machines.

### BRIEF DESCRIPTION OF THE DRAWINGS

FIG. 1 is a perspective view of a portable wagering game machine according to an example embodiment.

FIG. 2 is a block diagram of an architecture, including a control system, for a wagering game machine according to an example embodiment.

FIG. 3 is a block diagram illustrating software components for a system of wagering game machines and servers according to an example embodiment.

FIGS. 4-6 are block diagrams of example configuration of wireless signal sources in a gaming establishment according to embodiments of the invention.

FIG. 7 is a flowchart illustrating methods according to embodiments of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The description of the various embodiments is to be construed as exemplary only and does not describe every possible instance of the invention. Numerous alternatives could be implemented, using combinations of current or future technologies, which would still fall within the scope of the claims. The following detailed description is, therefore, not to be taken in a limiting sense, and the scope of the present invention is defined only by the appended claims.

In general, the embodiments of the invention provide for management of portable wagering game machines, including determining whether the portable wagering game machine is authenticated and authorized to play wagering games, whether an authenticated and authorized user is currently using the portable wagering game machine, and whether the portable wagering game machine is in a location where wagering is allowed, or where a particular style of wagering is allowed.

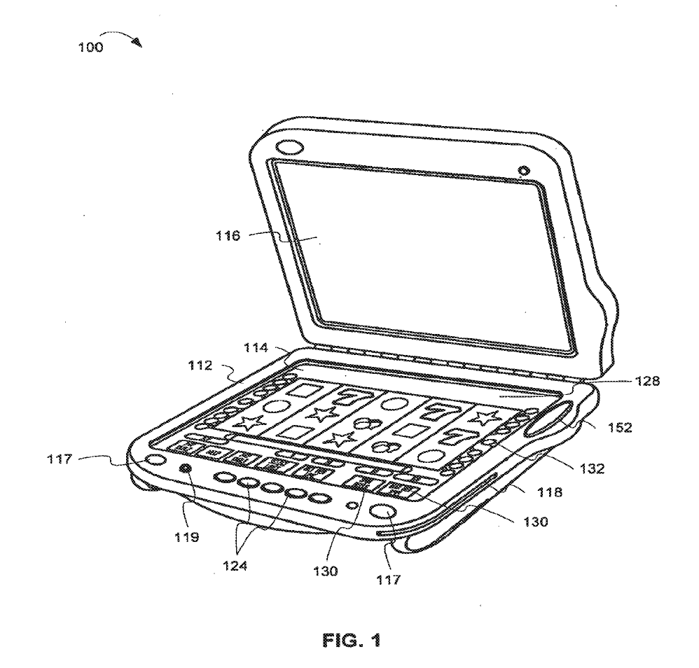

FIG. 1 shows an example embodiment of a portable wagering game machine (PWGM) 100. The portable wagering game machine 100 can include any suitable electronic handheld or mobile device configured to play a video casino game such as blackjack, slots, keno, poker, blackjack, and roulette. The wagering game machine 100 comprises a housing 112 and includes input devices, including a value input device 118 and a player input device 124. For output, the wagering game machine 100 includes a primary display 114, and may include a secondary display 116, one or more speakers 117, one or more player-accessible ports 119 (e.g., an audio output jack for headphones, a video headset jack, etc.), and other conventional I/O devices and ports, which may or may not be player-accessible. In the embodiment depicted in FIG. 1, the wagering game machine 100 includes a secondary display 116 that is rotatable relative to the primary display 114. The optional secondary display 116 can be fixed, movable, and/or detachable/attachable relative to the primary display 114. Either the primary display 114 and/or secondary display 116 can be configured to display any aspect of a non-wagering game, wagering game, secondary game, bonus game, progressive wagering game, group game, shared-experience game or event, game event, game outcome, scrolling information, text messaging, emails, alerts or announcements, broadcast information, subscription information, and wagering game machine status.

The player-accessible value input device 118 can comprise, for example, a slot located on the front, side, or top of the casing 112 configured to receive credit from a stored-value card (e.g., casino card, smart card, debit card, credit card, etc.) inserted by a player. The player-accessible value input device 118 can also comprise a sensor (e.g., an RF sensor) configured to sense a signal (e.g., an RF signal) output by a transmitter (e.g., an RF transmitter) carried by a player. The player-accessible value input device 118 can also or alternatively include a ticket reader, or barcode scanner, for reading information stored on a credit-ticket, a card, or other tangible portable credit or funds storage device. The credit ticket or card can also authorize access to a central account, which can transfer monetary value to the wagering game machine 100.

Still other player-accessible value input devices 118 can require the use of touch keys 130 on the touch-screen display (e.g., primary display 114 and/or secondary display 116) or player input devices 124. Upon entry of player identification information and, preferably, secondary authorization information (e.g., a password, PIN number, stored value card number, predefined key sequences, etc.), the player can be permitted to access a player's account. As one potential optional security feature, the wagering game machine 100 can be configured to permit a player to only access an account the player has specifically set up for the wagering game machine 100. Other conventional security features can also be utilized to, for example, prevent unauthorized access to a player's account, to minimize an impact of any unauthorized access to a player's account, or to prevent unauthorized access to any personal information or funds temporarily stored on the wagering game machine 100.

The player-accessible value input device 118 can itself comprise or utilize a biometric player information reader which permits the player to access available funds on a player's account, either alone or in combination with another of the aforementioned player-accessible value input devices 118. In an embodiment wherein the player-accessible value input device 118 comprises a biometric player information reader, transactions such as an input of value to the wagering game machine 110, a transfer of value from one player account or source to an account associated with the wagering game machine 100, or the execution of another transaction, for example, could all be authorized by a biometric reading, which could comprise a plurality of biometric readings, from the biometric device.

Alternatively, to enhance security, a transaction can be optionally enabled only by a two-step process in which a secondary source confirms the identity indicated by a primary source. For example, a player-accessible value input device 118 comprising a biometric player information reader can require a confirmatory entry from another biometric player information reader 152, or from another source, such as a credit card, debit card, player ID card, fob key, PIN number, password, hotel room key, etc. Thus, a transaction can be enabled by, for example, a combination of the personal identification input (e.g., biometric input) with a secret PIN number, or a combination of a biometric input with an authentication fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 118 can be provided remotely from the wagering game machine 110.

The player input device 124 may include a plurality of push buttons on a button panel for operating the wagering game machine 100. In addition, or alternatively, the player input device 124 can comprise a touch screen mounted to the primary display 114 and/or secondary display 116. In one aspect, the touch screen is matched to a display screen having one or more selectable touch keys 130 selectable by a user's touching of the associated area of the screen using a finger or a tool, such as a stylus pointer. A player enables a desired function either by touching the touch screen at an appropriate touch key 130 or by pressing an appropriate push button on the button panel. The touch keys 130 can be used to implement the same functions as push buttons. Alternatively, the push buttons 126 can provide inputs for one aspect of the operating the game, while the touch keys 130 can allow for input needed for another aspect of the game. The various components of the wagering game machine 100 can be connected directly to, or contained within, the casing 112, as seen in FIG. 1, or can be located outside the casing 112 and connected to the casing 112 via a variety of wired (tethered) or wireless connection methods. Thus, the wagering game machine 100 can comprise a single unit or a plurality of interconnected (e.g., wireless connections) parts which can be arranged to suit a player's preferences.

The operation of the basic wagering game on the wagering game machine 100 is displayed to the player on the primary display 114. The primary display 114 can also display a bonus game associated with the basic wagering game. The primary display 114 preferably takes the form of a high resolution LCD, a plasma display, an LED, or any other type of display suitable for use in the wagering game machine 100. The size of the primary display 114 can vary from, for example, about a 2-3″ display to a 15″ or 17″ display. In at least some embodiments, the primary display 114 is a 7″-10″ display. In one embodiment, the size of the primary display can be increased. Optionally, coatings or removable films or sheets can be applied to the display to provide desired characteristics (e.g., anti-scratch, anti-glare, bacterially-resistant and anti-microbial films, etc.). In at least some embodiments, the primary display 114 and/or secondary display 116 can have a 16:9 aspect ratio or other aspect ratio (e.g., 4:3). The primary display 114 and/or secondary display 116 can also each have different resolutions, different color schemes, and different aspect ratios.

A player typically begins play of the basic wagering game on the wagering game machine 100 by making a wager (e.g., via the value input device 118 or an assignment of credits stored on the portable wagering game machine 100 via the touch screen keys 130, player input device 124, or buttons 126) on the wagering game machine 100. In some embodiments, the basic game can comprise a plurality of symbols arranged in an array, and includes at least one payline 132 that indicates one or more outcomes of the basic game. Such outcomes can be randomly selected in response to the wagering input by the player. At least one of the plurality of randomly selected outcomes can be a start-bonus outcome, which can include any variations of symbols or symbol combinations triggering a bonus game.

In some embodiments, the player-accessible value input device 118 of the wagering game machine 100 can double as a player information reader 152 that allows for identification of a player by reading a card with information indicating the player's identity (e.g., reading a player's credit card, player ID card, smart card, etc.). The player information reader 152 can alternatively or also comprise a bar code scanner, RFID transceiver or computer readable storage medium interface. In one embodiment, the player information reader 152 comprises a biometric sensing device.

In some embodiments, a portable wagering game machine 100 can part of a portable wireless communication device, such as a personal digital assistant (PDA), a laptop or portable computer with wireless communication capability, a web tablet, a wireless telephone, a wireless headset, a pager, an instant messaging device, a digital camera, a television, or other device that can receive and/or transmit information wirelessly.

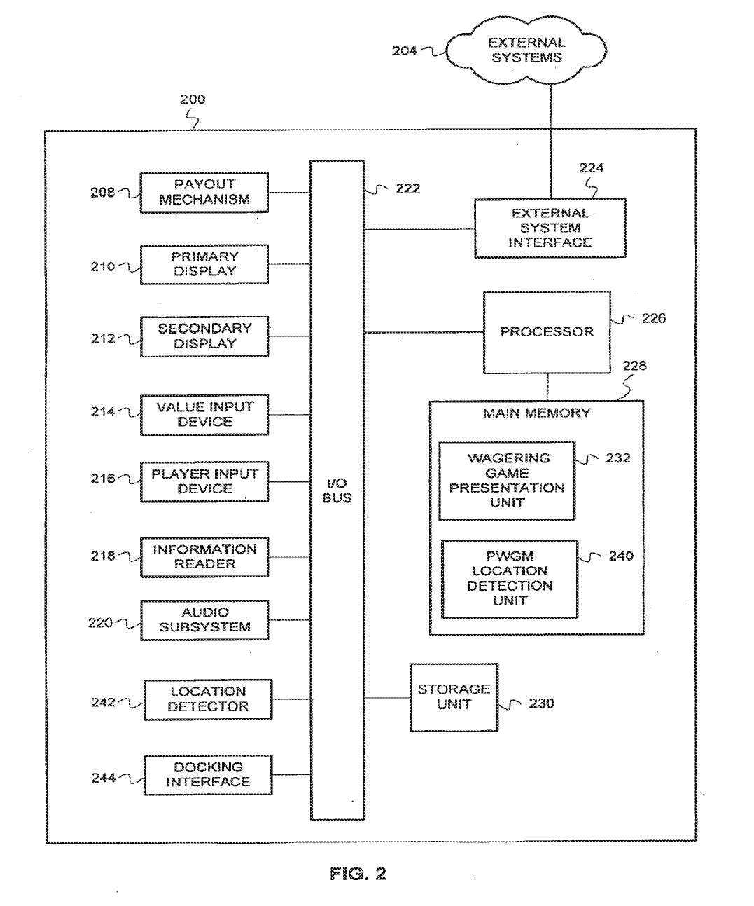

FIG. 2 is a block diagram illustrating an architecture 200, including a control system, for a portable wagering game machine, according to example embodiments of the invention. As shown in FIG. 2, the architecture 200 includes a processor 226 connected to main memory 228, which may include portable wagering game presentation unit 232 and portable wagering game location unit 240.

In one embodiment, the wagering game presentation unit 232 can present wagering games, such as video poker, video blackjack, video slots, video lottery, etc., in whole or part. Portable wagering game location detection unit 240 includes components that determine a location for a portable wagering machine 200, and will be further described below.

The processor 226 is also connected to an input/output (I/O) bus 222, which facilitates communication between the wagering game machine's components. The I/O bus 222 may be connected to a payout mechanism 208, primary display 210, secondary display 212, value input device 214, player input device 216, information reader 218, and/or storage unit 230. The player input device 216 can include the value input device 214 to the extent the player input device 216 is used to place wagers. The I/O bus 222 may also be connected to an external system interface 224, which is connected to external systems 204 (e.g., wagering game networks).

Some embodiments of the invention include an audio subsystem 220. Audio subsystem 220 provides audio capabilities to the wagering game machine and may comprise an audio amplifier coupled to speakers or an audio jack, and may further include an audio programming source on a memory such as a CD, DVD, flash memory etc.

In some embodiments, architecture 200 may include a location detector 242 coupled to I/O bus 222. The location detector may be any device that can determine or assist in the determination of a current location of a portable wagering game machine incorporating architecture 200. In some embodiments, location detector 242 may be a GPS (Global Positioning System) based detector. In alternative embodiments, location detector 242 may comprise a Bluetooth device. For example, location detector 242 may be a Bluetooth transceiver that either reads Bluetooth information from other Bluetooth devices such as devices having beacons. The Bluetooth information may differ depending on which Bluetooth device is supplying information, such that the Bluetooth device may be identified. Alternatively, location detector 242 may be a wireless network receiver or transceiver that can at least read information, including beacon information, from one or more wireless networking devices such as wireless networking access points. In still further embodiments, location detection 242 may be an inertial guidance based system.

The portable wagering game architecture 200 may include a docking interface 244. Docking interface 244 communicably couples the portable wagering game machine to a docking station or other interface. The portable wagering game machine may receive power through the docking interface (e.g. to charge a batter on the portable wagering game machine). In addition, the docking interface may enable communications with other computer systems or server systems through which the portable wagering game machine may receive configuration information or location data.

In one embodiment, the wagering game machine architecture 200 can include additional peripheral devices and/or more than one of each component shown in FIG. 2. For example, in one embodiment, the wagering game machine architecture 200 can include multiple external system interfaces 224 and multiple processors 226. In one embodiment, any of the components can be integrated or subdivided. Additionally, in one embodiment, the components of the wagering game machine architecture 200 can be interconnected according to any suitable interconnection architecture (e.g., directly connected, hypercube, etc.).

In one embodiment, any of the components of the wagering game machine architecture 200 (e.g., the wagering game presentation unit 232 or portable wagering game management unit) can include hardware, firmware, and/or software for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

In operation, a player may use the portable wagering game machine to activate a play of a wagering game on the machine. Using the available input mechanisms such as value input device 214 or devices coupled through player input device 216, the player may select any variables associated with the wagering game and place his/her wager to purchase a play of the game. In a play of the game, the processor 226 generates at least one random event using a random number generator (RNG) and provides an award to the player for a winning outcome of the random event. Alternatively, the random event may be generated by a remote computer using an RNG or pooling schema and then transmitted to the wagering game machine. The processor 226 operates the display 114 to represent the random event(s) and outcome(s) in a visual form that can be understood by the player.

In some embodiments, the architecture 200 uses the elements described above and the components and methods detailed below to determine a location of a portable wagering game machine 100. Such a determination may be used to further determine if the portable wagering game machine 100 is in a location in which wagering games may be played by an authorized user.

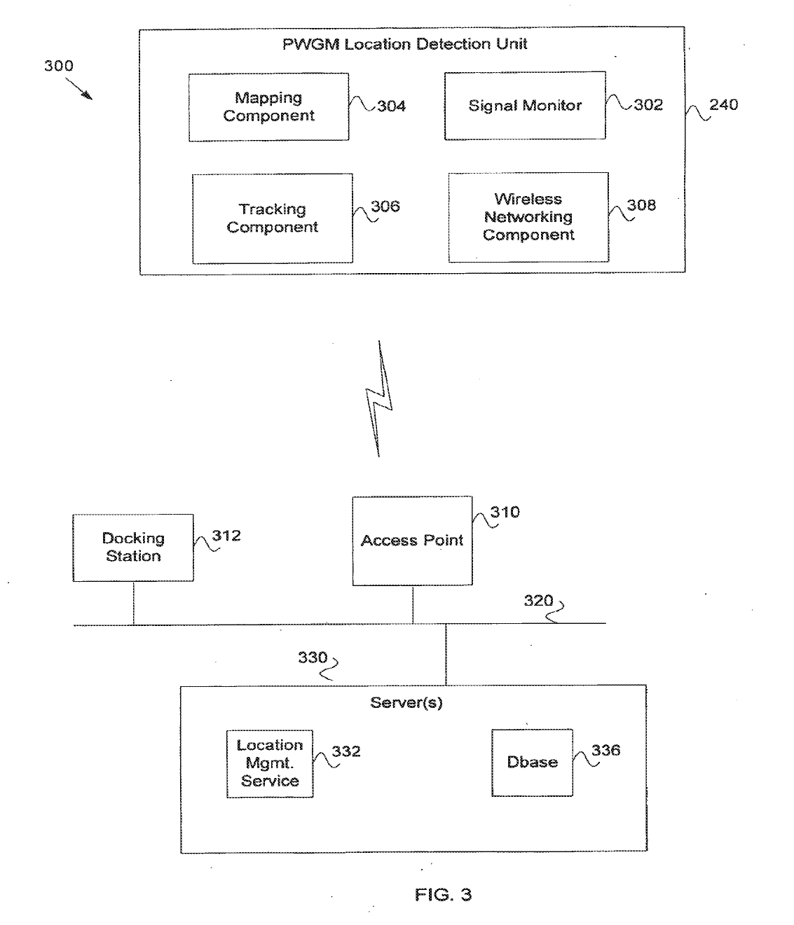

FIG. 3 is a block diagram illustrating major logical components of a system 300 according to embodiments of the invention, including portable wagering location detection unit 240 components, service components running on one or more servers 330 and interface components such as docking station 312 and wireless access point 310.

In general, location detection component 240 comprises software, firmware, and/or hardware that may be used to determine a current location of a portable wagering game machine 100. The location detection component 240 may receive data from a location detector 242, or may receive data from a location management service 332 in order to determine the current location.

Alternatively, location detection component 302 may analyze signal strength values received from various wireless signal sources such as beacons (e.g. Bluetooth beacons) or signal strength values received via wireless networking component 308 or external system interface 224 to determine a current location. Location detection component 302 may receive multiple signal strength indications representing signal strengths from multiple wireless signal sources such as beacons for Bluetooth devices or access points and use the signal strength values to determine a location for the portable wagering game machines. Additionally, location detection component 302 may be able to determine a position based on the timing of the arrival of signals such as beacon signals from various types of wireless devices.

As noted above, location detection component 302 may require data from location management service 332 in order to assist in determining the location of the portable wagering game machine 100. For example, location management service 332 may provide data on the location of wireless signal sources such as Bluetooth beacons and/or wireless access points. Such data can then be used to determine a current position of the portable wagering game machine. Data regarding the location and configuration of various wireless signal sources such as access points 310 or Bluetooth beacons may be maintained in a database 336.

Wireless networking component 308 implements wireless network communications capability. Wireless networking component 308 may include various wireless network protocols as described above, and may also include network protocols such as a TCP/IP network stack and SSL (Secure Socket Layer) protocols. Wireless networking component 308 may use external system interface 224 to communicate with an access point 310.

In some embodiments, a portable wagering game machine location detection unit 240 may include one or more of a signal monitor component 302, mapping component 304 and a tracking component 306. Signal monitor component 302 may interface with wireless networking component 308, and listen for signals received via a location detector or wireless interface. In some embodiments, a signal monitor 302 is instantiated for each type of wireless source supported by the PWGM. For example, in an environment where both wireless networking and Bluetooth are supported, two signal monitors may be instantiated, one for each protocol. Signal monitor 302 may the share the wireless or beacon identification information of observed wireless signal sources with other components such as mapping component 304 and tracking component 306.

Mapping component 304 provides location information for known beacons. This information may include a latitude and longitude, but may also contain other location information such as an antenna altitude, the age of the data, a learned propagation model, or the power of the transmitter. Mapping component 304 may obtain this data from database 336, or it may keep a copy of some or all of database 336 in a local database in portable wagering game machine 100.

Tracking component 306 may use a stream of data provided by the signal monitor and the associated data provided by the mapping component to produce an estimate of the portable wagering game machines current location. In some embodiments, the tracking component may use various aspects of wireless communication such as how various types of radio signals propagate and how propagation relates to distance, the physical environment and location. In some embodiments, tracking component 306 may apply a Bayesian filter to the signal information such as beacon specific range and propagation information.

Wireless access point 310 provides a portable wagering game machine 100 a link through which to communicate with other servers, services, or gaming machines on a network 320. Network 320 may be a wired or wireless network. In some embodiments, the wireless access point 310 and portable wagering game machines 100 may communicate via signals over one or more communication channels. In some embodiments, the wireless access point 310 can be part of a communication station, such as wireless local area network (WLAN) communication station including a Wireless Fidelity (WiFi) communication station, or a WLAN access point (AP). In these embodiments, the portable wagering game machines 100 can be part of a mobile station, such as WLAN mobile station or a WiFi mobile station, although the embodiments of the invention are not limited in this respect.

In some other embodiments, the wireless access point 310 can be part of a broadband wireless access (BWA) network communication station, such as a Worldwide Interoperability for Microwave Access (WiMax) communication station, although the embodiments are not limited in this respect, as the wireless access point 310 can be part of almost any wireless communication device. In these embodiments, the portable wagering game machines 100 can be part of a BWA network communication station, such as a WiMax communication station, although the embodiments of the invention are not limited in this respect.

As noted above, various services may be provided by one or more servers 330 on a network 320. Location management service 332 may provide data to a portable wagering game device to assist the portable wagering game device in determining its location. Alternatively, location management service may determine a location for a portable wagering game device based on data received from the portable wagering game device, wireless access points or other entities on network 320. In some embodiments, location data for beacons, access points or other wireless signal sources may be stored by location management service 332 in a database 336.

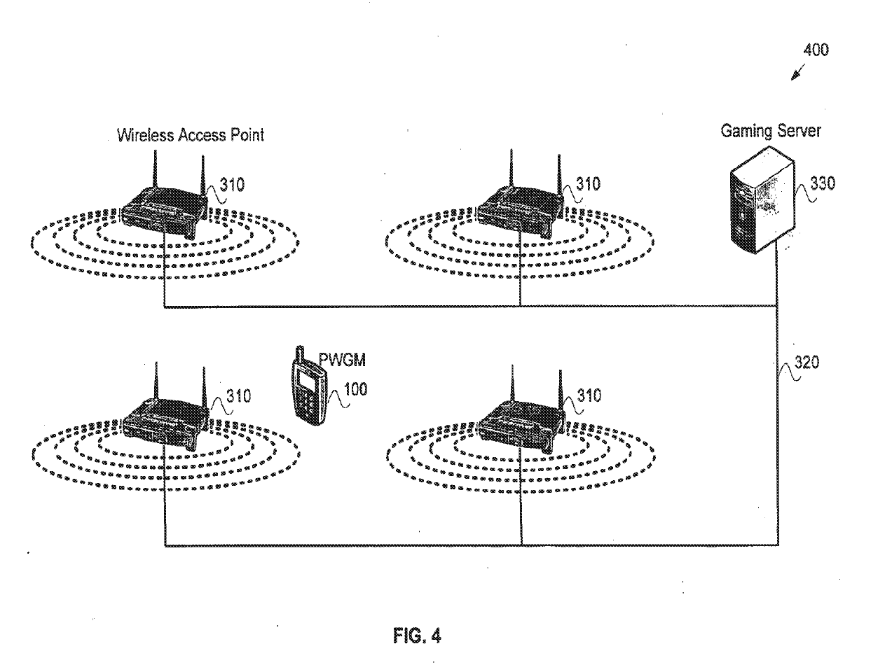

FIG. 4 is a block diagram of an example system 400 of wireless signal sources 310, portable wagering game machines 100 and servers 330 in a gaming establishment and is used to illustrate embodiments of the invention. In some embodiments, an array of wireless access points (which may be low power wireless access points) are placed in predetermined locations. The access points 310 may be positioned in a pattern or grid to facilitate location within a coordinate system. Alternatively, the access points may be positioned at specific locations such as tables or seating areas with no particular pattern. The location of each wireless access point may be maintained in a database 336.

The system may also include one or more servers 330, which may be central game controllers. PWGMs 100 may communicate through the wireless access points 310. As illustrated in FIG. 3, server 330 may be programmed or supplied with the actual locations of the wireless access points, such as through database 336.

In some embodiments, access points 310 are part of a mesh network to reduce wiring and installation cost. However, the access points may be hardwired to the server 330 to provide increased bandwidth. Hybrid schemes are also possible where some of the access points 310 are hardwired and others reside on a mesh network.

Each PWGM 100 may be assigned a unique identifier that is used in communication via the wireless access points. Based on location and signal strength, more than one access point 310 may establish communication with a particular PWGM 100. In some embodiments, the system will include the received signal strength in the information reported to a location management server 332 on server 330. This information may then be used by the location management service 332 to interpolate the actual location of the PWGM 100.

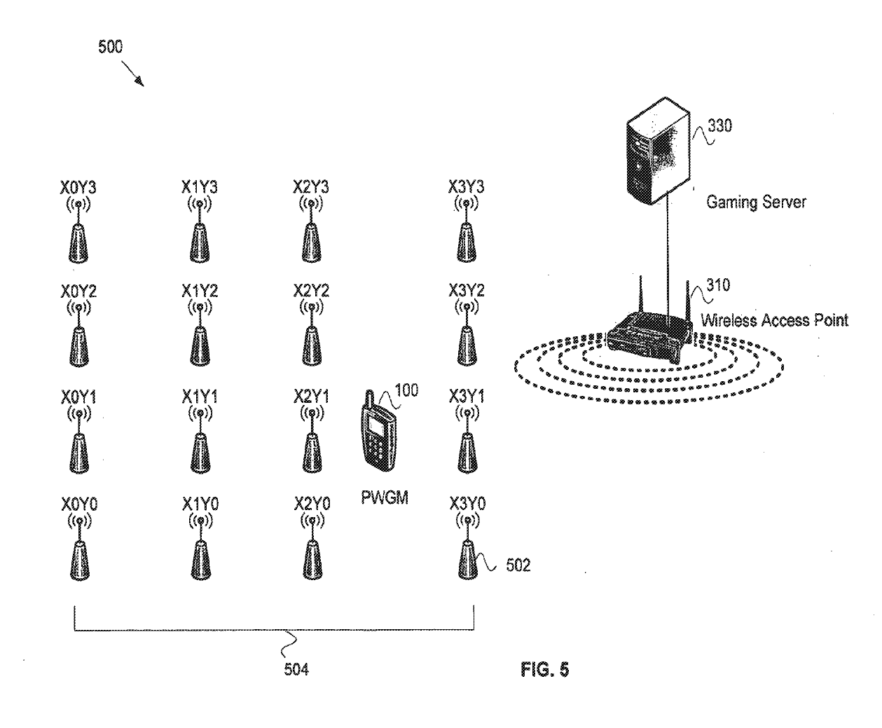

FIG. 5 is a block diagram of an example system 500 of wireless signal sources according to further embodiments of the invention. In some embodiments, system 500 implements an array of wireless signal sources comprising point locator transmitters 502. These points are arranged in a pattern such as the grid 504 illustrated in FIG. 5. It should be noted that although a grid is depicted, any predetermined arrangement of points may be used.

Each point transmitter 502 transmits a unique locator signal that corresponds to a specific point within the pattern. These locator signals are designated as X0Y0-X3Y3 in FIG. 5. By receiving locator signals from at least one point the approximate location of a PWGM 100 may be determined.

In some embodiments, system 500 may also include one (or more) server 330s, which may be central game controllers, and one (or more) Wireless Access Points 310. The servers 330 and the PWGMs 100 communicate through the Wireless Access Points 310.

In some embodiments, a PWGM 100 reports the received locator location signal(s) to a location management service 332 on server 330. From this information the location management service may determine the location of each PWGM 100.

In some embodiments, to prevent a rogue PWGM 100 from spoofing the system or reporting a false location, it is desirable that the unique locator signals be encoded and changed frequently in a random or unpredictable manner such that the correspondence between a particular locator signal and a locator point is only known to the server 330. This will prevent a rogue PWGM from sending a predetermined “good” location regardless of its actual location.

Based on location and locator signal strength, a PWGM 100 may receive signals from more than one locator point 502. The system may include the received locator signal strength in the information reported to the location management service 332. This information may then be used to interpolate the actual location of the PWGM 100.

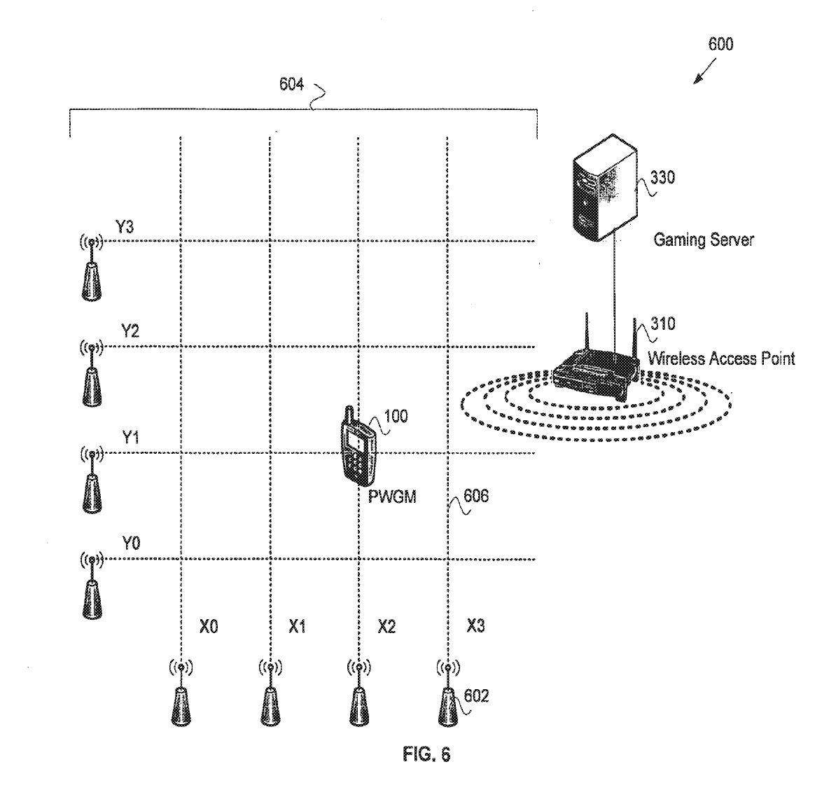

FIG. 6 is a block diagram of an example system 600 of wireless signal sources according to still further embodiments of the invention. In general, system 600 includes a grid 604 of location transmitters 602. System 600 employs a number of transmission wires 606. These wires 606, which act as antennas are arranged in an intersecting pattern such as the grid 604 depicted in FIG. 6. It should be noted that although a grid is depicted, any predetermined arrangement of intersecting antenna wires may be used. The wires may be located in the floor or ceiling of the space being monitored.

Each wire 606 carries a unique locator signal that corresponds to a specific line within the pattern. These locator signals are designated as X0-X3 and Y0-Y3 in FIG. 6. By receiving locator signals from two intersecting wires the approximate location of a PWGM 100 may be determined.

The system may also include one (or more) servers 330, which may be central game controllers and one (or more) Wireless Access Points 310. The servers 330 and the PWGMs 100 communicate through the Wireless Access Points 310.

A PWGM 100 may report the received locator location signals to the server 330. From this information a server 330 may determine the location of the PWGM 100.

To prevent a rogue PWGM from spoofing the system or reporting a false location, it is desirable that the unique locator signals be encoded and changed frequently in a random or unpredictable manner such that the correspondence between a particular locator signal and a locator wire is only known to the server 339. This may aid in preventing a rogue PWGM from sending a predetermined “good” location regardless of its actual location.

Based on location and locator signal strength, a PWGM 100 may receive more than two intersecting locator signals. The system 600 may include the received locator signal strength in the information reported to the server 330. This information may then be used by the server 330 to interpolate the actual location of the PWGM 100.

In some embodiments, a single locator transmitter may be used. In this configuration the transmitter may be switched from one locator wire to the next in sequence.

In some embodiments, a PWGM 100 includes an inertial navigation system. The principles of inertial navigation systems are well known and are not fully detailed here. In general, an inertial navigation system provides the position, velocities and attitude of a platform by measuring the acceleration and rotation of the platform. It accumulates these measurements over time to calculate the current position and attitude.

Inertial navigation systems do not rely on any outside systems and are therefore immune to jamming and deception. However, errors in measurement and calculation are typically cumulative so the position and attitude of the platform may become progressively less accurate over time.

In some embodiments, an inertial navigation system into a location detector 242 of a PWGM 100. A PWGM 100 may calibrate its position whenever it is ‘docked’, for example at a docking station 312 and would rely on the inertial navigation system when it is not docked. In these embodiments, a PWGM 100 may report its location to the server 330.

In some embodiments, a hybrid of systems 400, 500 or 600 may used. For example, an array of low power access points may be used to determine the general location of the PWGM 100 and the inertial guidance system may be used to pinpoint its exact location.

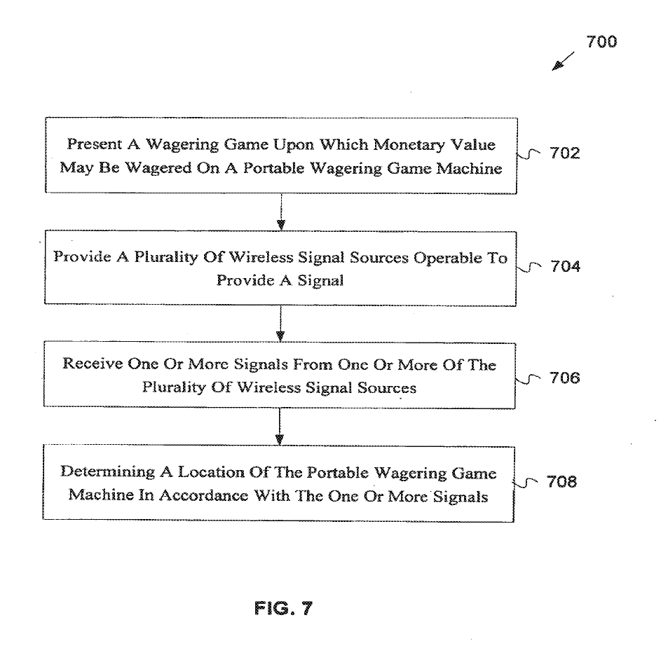

FIG. 7 is a flowchart illustrating methods for determining a location for a portable wagering game machine or other device in a wagering game network according to embodiments of the inventive subject matter. The method begins at block 702 by providing a portable wagering game machine that may present a wagering game upon which monetary value may be wagered. As noted above, the wagering game may be any type of wagering game, including video poker, slots, bingo, keno, YAHTZEE® etc.

At block 704, the method includes providing a plurality of wireless signals. The signals may be provided by access points, beacons, or any other type of wireless signal source. In some embodiments, a signal produced by the signal source includes an identifier for the source of the signal. Further, in some embodiments the wireless signal sources are arranged in predetermined locations that are intended to enhance the ability to determine the location of portable devices within the system. For example, in some embodiments, the wireless signal sources may be arranged in a grid.

At block 706, the portable wagering game machine receives signals from one or more of the plurality of signal sources. It should be noted that the signals may be used for functions other than determining a location for a portable wagering game machine. The signals may transmit wagering game related data, accounting data, advertising data, player tracking data, or any other type of data usable in a wagering game environment.

At block 708, a device within the system determines a location of the portable wagering game machine in accordance with the one or more signals. The location may be determined by the portable wagering game machine itself, or data received by the portable wagering game machine may be sent to a location management service that determines, based on the data, a location for the portable wagering game machine.

In addition to the actions detailed above for FIG. 7, methods used in various embodiments may incorporate features or actions discussed above with respect to FIGS. 1-6.

### CONCLUSION

Systems and methods for determining a location for portable wagering game machines have been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the inventive subject matter.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

The Abstract is provided to comply with 37 C.F.R. .sctn. 1.72(b) to allow the reader to quickly ascertain the nature and gist of the technical disclosure. The Abstract is submitted with the understanding that it will not be used to limit the scope of the claims.

What is claimed is:

1. A passive location detection system comprising:
a plurality of wireless signal sources arranged in predetermined physical locations in a gaming establishment, each of the plurality being configured to provide a signal that includes at least one of location information or identity information of the respective wireless signal source of the plurality;
a location server including one or more processors configured, individually or in combination, to determine a location of a handheld wagering game machine in the gaming establishment, the handheld wagering game machine including a location detection component; and
wherein two or more wireless signal sources of the plurality are configured to establish communication with the handheld wagering game machine at a particular location, wherein the handheld wagering game machine, via the location detection component, is configured to receive the respective signals from the two or more wireless signal sources and to transmit, via the location detection component, the location information or the identity information contained in the received signals to the location server, wherein the one or more processors determine the particular location of the handheld wagering game machine based, at least in part, on the location information or the identity information.

2. The passive location detection system of claim 1, wherein the plurality of wireless signal sources includes wireless access points.

3. The passive location detection system of claim 1, wherein the plurality of wireless signal sources includes transmitter beacons.

4. The passive location detection system of claim 1, wherein the predetermined physical locations correspond to a grid coordinate system, and wherein each signal includes coordinate information corresponding to the grid coordinate system.

5. The passive location detection system of claim 1, wherein location detection component is further configured to receive signals from a plurality of wireless signal source types, and to instantiate a signal monitor for each type of wireless signal source supported by the location detection component.

6. The passive location detection system of claim 1, wherein the location detection component is configured to analyze signal strengths of received signals and to include signal strength data with the location information or identity information transmitted to the location server for use in determining the particular location of the handheld wagering game machine.

7. The passive location detection system of claim 1, wherein the plurality of wireless signal sources are further configured to encode the provided signals according to a coding format and wherein instructions for decoding the encoded signals are known only to the location server.

8. The passive location detection system of claim 7, wherein a coding format for encoding the provided signals is changed frequently in a random or unpredictable manner.

9. A method of determining a physical location of a handheld wagering game machine via a system including a location server and a plurality of wireless signal sources arranged in predetermined physical locations in a gaming establishment, the method comprising:
providing, via each of the plurality of wireless signal sources, a signal that includes at least one of location information or identity information of the respective wireless signal source;
receiving, by the handheld wagering game machine while at a particular location, signals from two or more wireless signal sources of the plurality;
transmitting, from the handheld wagering game machine to the location server, the location information or identity information contained in the received signals; and
determining, by one or more processors of the location server, the particular location of the handheld wagering game machine based, at least in part, on the location information or identity information.

10. The method of claim 9, wherein the location information or identity information transmitted to the location server includes received signal strength, and wherein determining the particular location of the handheld wagering game machine includes using the received signal strength to interpolate the particular location.

11. The method of claim 9, further comprising encoding the signals provided by the plurality of wireless signal sources according to a coding format, wherein instructions for decoding the encoded signal are known only to the location server.

12. The method of claim 11, wherein the coding format for encoding the signals is changed frequently in a random or unpredictable manner.

13. The method of claim 9, wherein the location detection component is configured to analyze arrival times of received signals and to include arrival time data with the location information or identity information transmitted to the location server for use in determining the particular location of the handheld wagering game machine.

14. The method of claim 9, wherein the signals provided by each of the wireless signal sources further includes at least one of wagering game-related data, accounting data, or player tracking data.

15. A passive location detection system comprising:
a plurality of wireless signal sources arranged in predetermined physical locations in a gaming establishment, each of the plurality being configured to provide a signal encoded via a coding format, each encoded signal including at least one of location information or identity information of the respective wireless signal source of the plurality;
a location server including one or more processors configured, individually or in combination, to determine a location of a handheld wagering game machine in the gaming establishment, the handheld wagering game machine including a location detection component; and
wherein the handheld wagering game machine at a particular location is configured to establish communication with two or more wireless signal sources of the plurality and to receive the encoded signals, via the location detection component, from the two or more wireless signal sources and to transmit, via the location detection component, the received encoded signals to the location server, and wherein the one or more processors are configured to decode the signals and to determine the particular location of the handheld wagering game machine based, at least in part, on the location information or the identity information.

16. The passive location detection system of claim 15, wherein the coding format for encoding the signals is changed frequently in a random or unpredictable manner.

17. The passive location detection system of claim 15, wherein the predetermined physical locations correspond to a grid coordinate system, and wherein the each signal includes coordinate information corresponding to the grid coordinate system.

18. The passive location detection system of claim 15, wherein the predetermined physical locations of the plurality are stored in a database at the location server, and wherein the particular location is determined by reference to the database.

19. The passive location detection system of claim 15, wherein the location detection component is configured to analyze signal strengths of received signals and to include signal strength data with the location information or identity information transmitted to the location server for use in determining the particular location of the handheld wagering game machine.

20. The passive location detection system of claim 15, wherein the coded signals provided by each of the wireless signal sources further includes at least one of wagering game-related data, accounting data, or player tracking data.
